(19) United States
(12) Patent Application Publication
(10) Pub. No.: US 2006/0092928 A1
(43) Pub. Date: May 4, 2006

(54) System and method for providing a shareable input/output device in a PCI express environment

(75) Inventors: Jimmy D. Pike, Georgetown, TX (US); Frank H. Molsberry II, Georgetown, TX (US)

Correspondence Address: Brian E. Szymczak;Baker Botts L.L.P., One Shell Plaza, 910 Louisiana, Houston, TX, 77002-4995, US

(73) Assignee: Dell Products L.P., Round Rock, TX (US)

(21) Appl. No.: 10/966,293

(22) Filed: Oct. 15, 2004

(51) Int. Cl. H04L 12/66; G06F 13/00

(52) U.S. Cl. 370/355; 710/316

(57) ABSTRACT

The midplane of a modular information handling system includes a sharable PCI Express switch that is serially connect with each associated modular information handling system component and a network communication device. The shareable PCI Express switch acts to receive PCI Express packets from associated information handling system components, with each packet including a Transaction ID field. The shareable PCI Express switch assigns a context value that identifies a particular modular information handling system component within the Transaction ID field of each PCI Express packet received from the connected modular information handling system component.

### TECHNICAL FIELD

The present invention is related to the field of computer systems and more specifically to a system and method for providing a shareable input/output device in a PCI Express environment.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a so called modular information handling system which may also be referred to as a modular server, blade server or brick server. Typically, blade servers utilize a midplane to allow multiple modular components (which may also be referred to as “server cards” or “blades”) to be associated within a single computer chassis. The multiple blades are then interconnected via the midplane and typically share a common power supply and other resources such as network communication and cooling system resources. Each blade typically includes an independent processor and memory. For modular systems that utilize a PCI Express environment for sending packets, each blade requires a separate communication device (sometimes referred to as an I/O device).

PCI Express environments utilize a serialized communication architecture. Such a serialized architecture is in contrast to the BUS-based parallel architecture of PCI, PCI-X and PCI-X 2.0 communications. In serialized environment that supports PCI-Express Communications, in modular information handling systems such as blade servers, each modular information handling system component requires its own I/O such as network interface card (NIC) or Fiber Channel (FC) card. Accordingly, for a blade server system to support a PCI-Express environment, the system will have multiple communication devices, adding significantly to the overall cost of the system.

Some attempts have been made to reduce the cost associated with having multiple network communication devices by employing encapsulation techniques to packets being sent from modular components to further identify the address of the modular component. Such encapsulation encompasses adding additional information to a standard PCI Express packet such that the encapsulated packet is larger than a standard PCI Express packet. This creates problems because the system to which the encapsulated packet is sent often encounters problems with receiving packets that do not conform to PCI-Express specifications.

The background should also address the use of encapsulation techniques that add information to a standard PCI express base packet for utilizing one input/output device for multiple servers. Background should also discuss drawbacks to this including the problems resulting from including a header or other non-standard information to a PCI express packet.

### SUMMARY OF THE INVENTION

Therefore a need has arisen for a system incorporating multiple initiators such as a modular information handling system in a PCI Express environment without requiring multiple input/output devices.

The present disclosure describes a modular information handling system that utilizes a shareable PCI Express switch to assign a context value within PCI Express packets that distinctly identify each associated modular information handling system component.

In one aspect, a modular information handling system includes a midplane that may connect with multiple modular information handling system components. Each information handling system component operable to initiate PCI Express packet-based communications. The midplane includes a sharable PCI Express switch that is serially connect with each associated modular information handling system component and a network communication device. The shareable PCI Express switch acts to receive PCI Express packets that each include a Transaction ID field from the connected modular information handling system components. The shareable PCI Express switch also assigns a context value that identifies a particular modular information handling system component, within the Transaction ID field of each PCI Express packet received from the connected modular information handling system component.

In another aspect a sharable PCI Express switch is disclosed that includes multiple ports for serially connecting with multiple information handling system components. The shareable switch also includes a context assignment module that serves to receive PCI Express packets that include a PCI Express packet Transaction ID field. The shareable switch then assigns a context value within the Transaction ID field of each PCI Express packet that identifies a particular modular information handling system component based upon the port from PCI Express packet was received.

In another aspect a method for addressing a PCI Express packet includes receiving a PCI Express packet from one of a plurality of associated modular information handling system components and then assigning a context value to the Transaction ID field of the PCI Express packet where the context value identifying the one modular information handling system component.

The present disclosure includes a number of important technical advantages. One technical advantage is to include a sharable PCI Express switch that assigns a context value within each PCI Express packet. This allows a modular information handling system to support a PCI Express environment without multiple network communication components. Additional advantages will be apparent to those of skill in the art from the FIGURES, description and Claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a modular information handling system with a sharable PCI express switch according to teachings of the present disclosure.

FIG. 2 shows a sharable PCI express switch having a packet context assignment module according to teachings of the present disclosure;

FIG. 3 shows a standard PCI express packet;

FIG. 4 is a flow diagram showing a method of assigning context information within a PCI Express base packet according to teachings of the present disclosure;

FIG. 5 is a flow diagram showing a method for distributing PCI Express packets utilizing context information; and

FIG. 6 is a flow diagram showing a method for assigning context values to associated information handling system components.

### DETAILED DESCRIPTION OF THE INVENTION

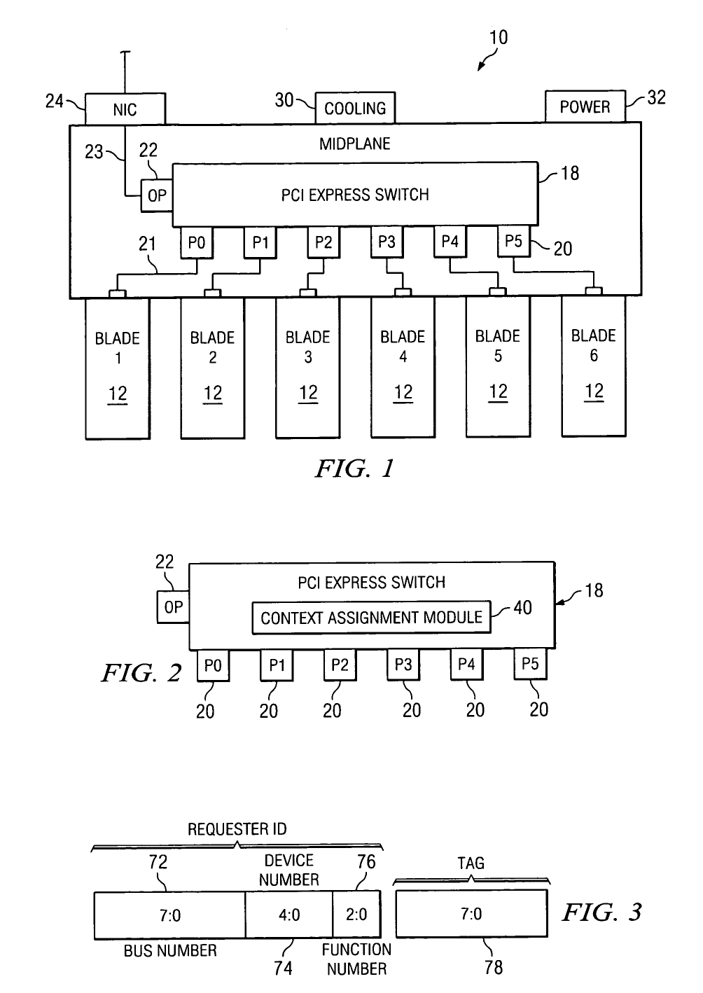

Preferred embodiments of the invention and its advantages are best understood by reference to FIGS. 1-6 wherein like number refer to like and corresponding parts.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Modular information handling systems are one type of information handling system. Modular information handling systems are sometimes referred to as “blade servers” or “brick servers” typically include multiple motherboards that are connected to a common midplane and housed within a single chassis. For example, the Dell PowerEdge 1655MC blade server manufactured by the Dell Computer Corporation® houses up to six blades. Each blade within the PowerEdge 1655MC is equipped with up to two 1.26 GH_{z} Intel® Pentium® III processors with a 133 MHz front side bus and 512 kB full speed cache. Additionally, each blade is equipped with two SCSI hard disk drives with an integrated hardware based Ultra 320 SCSI Raid Controller. Generally, modular information handling systems allow for increased manageability and data center efficiency because processing density is increased and because blades are able to share resources such as power supplies and cooling systems.

Now referring to FIG. 1, a diagram of a modular information handling system, depicted generally at 10, is shown. Modular information handling system 10 includes a midplane 14 with multiple modular information handling system components 12 attached thereto and a sharable PCI Express switch 18 incorporated therein. In the present embodiment, six blades 12 are connected with midplane 14. In alternate embodiments more or fewer blades may be associated with midplane 14. Each blade 12 is preferably connected with midplane 14 by a connector (not expressly shown) and each blade 12 is preferably in serial communication with shareable PCI Express switch 18.

Shareable PCI Express switch preferably incorporates an input/output (I/O) device such as, for instance, a 10 Gb network device for relaying information between information handling system components and an associated network. Shareable PCI Express switch 18 also includes a plurality of ports 20. In the present embodiment, PCI Express switch 18 includes six ports 20 labeled as P1-P6. In alternate embodiments PCI Express switch 18 may include more or fewer ports 20. Each port 20 serially connects, via serial communication connections 21, with individual blade servers 12. Shareable PCI Express switch 18 also includes output port 22 which serially connects with communication device 24. In the present embodiment output port 22 connects with communication device 24 via serial connection 23. In the present embodiment network communication device 24 may be a network interface card (NIC), a Fiber Channel (FC) card or another suitable network communication device.

Modular information handling system also includes a cooling resource 30 and a power supply 32 for providing respective cooling and power resources to blades 20.

In operation in a PCI Express compliant environment, PCI Express switch 18 receives standard PCI Express packets from the various associated blades 20. As described below with respect to FIG. 3, each PCI Express packet, as described in the PCI Express Specification, includes a Transaction ID comprised BUS Number field 72, a Device Number field 74, and a Function Number field 76, and a Tag 78. Bus number field 72 is preferably an eight bit field. Device number field 74 is preferably a five bit field. Function number field 76 is preferably a three bit field.

Bus number 72, device number 44, and function number 76 correspond with and retain the characteristic function of the corresponding fields defined in the parallel PCI and PCI-X specifications. However, because of the point-to-point nature of the PCI Express standard, few possible combinations of the transaction id filds be used Accordingly, the bulk of the combinations above an arbitrary value, chosen during system configuration, remain available to support sharing according to the teachings herein.

The present sharing approach requires that the existing programming model for the structure of PCI Express packets remain unchanged and that the PCI Express packets are not encapsulated or otherwise amended. This will allow the modular information system 10 as well as other systems in communication therewith to continue to operate without impacting the operating system or other utilities (such as drivers).

Shareable switch 18 manages the application of the desired register to PCI Express packets being sent therefrom. Each register set is associated exclusively with a modular information handling system component 12 or its operating system and are referred to herein as Contexts. By creating an I/O device such as PCI Express switch 18 with multiple contexts, each corresponding to distinct modular information handling system components 12 (or OS instance), and using the available Transaction IDs, a sharing approach for I/O devices such as PCI Express switch 18 is achieved.

The addressing scheme described herein may be utilized in conjunction with a conventional blade server and chipset and will preferably utilize the standard PCI Express addressing model. The system and method described herein must therefore be able to add the sharing information outside of the base chipset. In the present preferred embodiment, this can be done without modification to the PCI specification or protocol.

Now referring to FIG. 2, a shareable PCI Express switch 18 is shown. PCI Express switch 18 may also be referred to as shareable switch 18. PCI Express switch 18 includes a plurality of parts 20 for serially connecting with modular information handling system components such as blade servers. Shareable PCI Express switch 18 also includes an output part 22 for communicating with a NIC, a FC card, or another suitable network communication device. Sharable PCI Express switch 18 also includes context assignment module 40.

Context assignment module 40 acts to assign appropriate context values to PCI Express products received at ports 20. Context assignment module 40 preferably associates a district context value with each port 20.

As PCI Express switch 18 receives PCI Express packets from parts 20, the context value associated with each port is incorporated into the Transaction ID field of each packet. Preferably, normal PCI Express packet are created for transaction IDs with device number below a programmable value (0 thru N) and shareable I/O Device Context number corresponds to the normal PCI Device number greater than N). The remaining Context values created thru the combination of the bus number 72 and device number 74 represent the sharable extent of PCI Express switch 18 (number of blades, servers or other modular information handling system components that may share PCI Express switch 18).

The transaction Id for identifying the appropriate context is determined by context assignment module 40 using the number of the port 22 on the switch from which the PCI Express packet arrives. This information (the context value) is substituted by shareable switch 18 for the bus number and device number field. For example, in the present preferred embodiment Port 0 may be designated device number 1, Port 1 is designated device number 2, etc. The reverse will also be true for replies or interrupts; the device number will determine the correct port for the shareable switch 18 to send the message in a vice-versa fashion.

This scheme allows PCI Express switch 18 to be shared by multiple modular information handling system components while retaining the existing programming model. There are many advantages to such an approach. It is beneficial to configure the I/O subsystem (in this case the PCI Express switch) to more appropriately match the environment into which it is to be deployed. It is also advantageous to share an expensive I/O device (such as, for example, a 10 Gb Network device) amortizing the cost among multiple servers 12. Also, sharing an I/O device will eliminate the expense of high speed switch ports. It should be noted, that sharing a physical I/O device among servers may decrease private bandwidth. Additionally, certain environments may mandate a dedicated device for each associated blade.

Now referring to FIG. 3, a depiction of a standard PCI Express packet 50 is shown. PCI Express packet 50 includes a Transaction Layer Product (TLP) header 52 that includes four bytes of information in the following fields: format field 54, type field 56, traffic class 58, TD field 60, EP field 62, attribute field 54 and length field 66.

Format field 54 encompasses bits 6:5 of byte 0 of TLP header 52 and is used for listing the format of TLP. Type field 56 uses bits 4:0 of byte 0 and is used for listing the type of TLP. The format 54 and type 56 fields are used to provide the information required to determine the size of the remaining port of header 52, and if the packet contains a data payload following the header.

TC field 58 occupies bits 6:4 of byte 1 and is used to list the traffic class of the transaction. TD field 60 occupies bit 7 of byte 2 and indicates the presence of TLP digest in the form of a single double word (DW) at the end of the TLP. EP field 62 occupies bit 6 of byte 2 and indicates whether the TLP is poisoned. Attribute field 64 occupies bits 5:4 of byte 2 and is used to provide information that allows modification of the default handling of transactions. Length field 66 occupies bits 1:0 of byte 2 and bits 7:0 of byte 3 and indicates the length of the data payload.

PCI Express packet further includes a data payload 68 and a requester ID 70. Transaction ID includes bus number field 72, device number field 74 and function number field 76. Bus number field 72 utilities bits 0:7 of byte 0, device field 74 utilizes bits 0:3 of byte 1 and function number field 76 utilizes bits 2:0 of byte 1.

As described above, device number field 74 is preferably utilized to set the limit above which the combination of the bus number and device number will make up the context values used to identify the information handling system components 12 associated with PCI Express switch 18.

The PCI Express specification is a serial encapsulation of the parallel PCI programming model and operation. As such BUS Number 72, Device Number 74, and Function Number 76 as defined by the parallel PCI or PCI-X standards are retained. Their placement in the currently defined bit stream for PCI Express is shown in FIG. 3 as described above.

Bus number field 72, Device number field 74, and Function number field 76 retain the characteristic function of the parallel PCI specification. However, because of the point-to-point nature of PCI Express, a limited number of combinations for the bus number 72 and the device number 74 will be used. This leaves combinations above a configurable limit available to support the concept of sharing described herein.

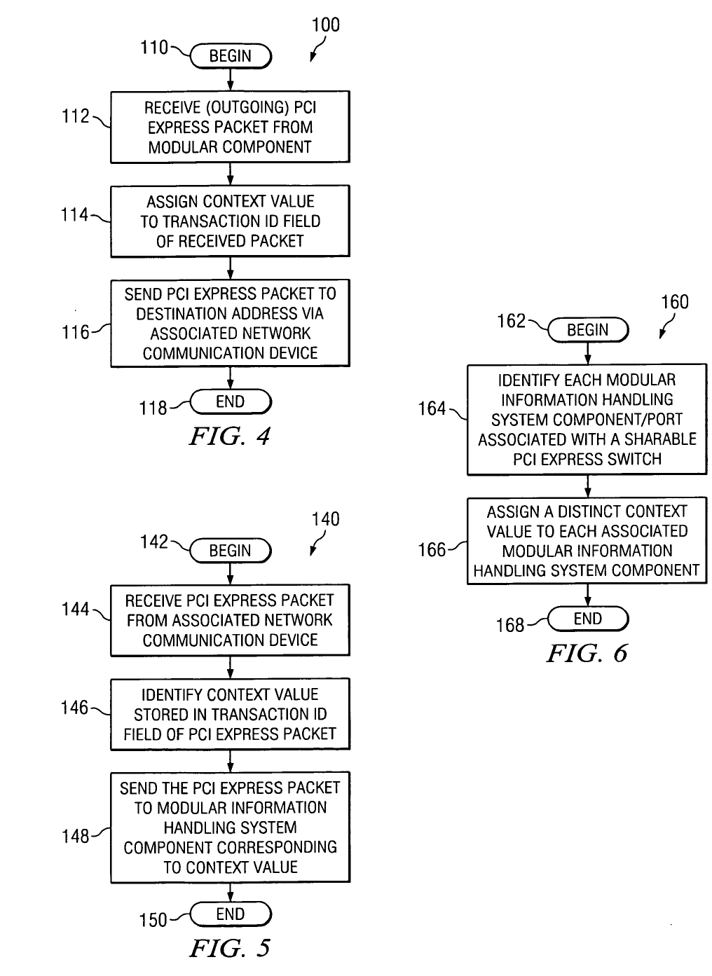

Now referring to FIG. 4, a flow diagram 100 showing a method of assigning context information within a PCI Express base packet. The method begins 110 when a PCI Express packet is received by a sharable PCI Express switch 112. In certain embodiments, this will occur when a modular information handling system component (such as a blade server) sends a PCI Express packet. After the packet is received, the sharable switch assigns a context value to the receive packet based upon the port from which it was received and inserts the context value transaction ID 114. The sharable PCI Express switch then sends the packet (with its revised transaction ID field) to its destination address 116. In the present preferred embodiment an associated network communication device is utilized to send the packets out to an associated network. The method ends 118 until the next PCI Express packet send by an associated blade is received.

Now referring to FIG. 5, a flow diagram 140 of a method for distributing PCI Express packets utilizing context information is shown. The begins 142 as PCI Express packets are received by a sharable PCI Express switch 144. The received PCI Express packet or packets is preferably received via a network communication device (such as a NIC) that is associated with the sharable PCI Express Switch. The sharable PCI Express Switch then identifies the context value stored in the Transaction ID field of the PCI Express packet 146. Next the sharable PCI Express switch sends the PCI Express Packet to the information handling system component that corresponds to the value stored within the Transaction ID field 148. The method ends 150, until the next PCI Express packet being sent to an associated blade is received.

Now referring to FIG. 6, a flow diagram 160 for assigning context values to associated information handling system components is shown. The method begins 162 by identifying each associated modular information handling system component (or port for serially linking with a modular information handling system component) 164. Next, each associated port or component is then assigned a context value for use in carrying out the operation shown in FIGS. 5 and 6, above. The method then ends 168. In some embodiments, the methods shown in FIGS. 4-6 may be combined in order to manage PCI Express packets being sent to and from the associated information handling system components.

Although the disclosed embodiments have been described in detail, it should be understood that various changes, substitutions and alterations can be made to the embodiments without departing from their spirit and scope

What is claimed is:

1. A modular information handling system comprising:
a midplane operable to receive a plurality of modular information handling system components, each information handling system component operable to initiate PCI Express packet-based communications;
a sharable PCI Express switch associated with the midplane, the shareable PCI Express switch operable to serially connect with each associated modular information handling system component associated with the midplane and an associated network communication device, the shareable PCI Express switch operable to:
receive PCI Express packets from one or more associated modular information handling system components, where each PCI Express packet comprises a Transaction ID field; and
assign a context value within the Transaction ID field of each PCI Express packet received from an associated modular information handling system component, each context value identifying a particular modular information handling system component.

2. The system of claim 1 further comprising a plurality of blade servers associated with the midplane.

3. The system of claim 1 further comprising the shareable PCI Express switch comprising a plurality of ports, each port operable to serially connect with one associated modular information handling system component, the shareable PCI Express switch further operable to associate a distinct context value for each of the plurality of ports.

4. The system of claim 1 further comprising a power source associated with the midplane operable to provide power to the midplane and a plurality of modular information handling system components associated with the midplane.

5. The system of claim 1 further wherein the network communication device further comprises a network interface card.

6. The system of claim 1 further comprising at least one cooling module associated with the midplane.

7. The system of claim 1 further comprising the sharable PCI Express switch operable to send the PCI Express packet to the communication device.

8. The system of claim 7 further operable to send non-encapsulated PCI Express packets.

9. The system of claim 1 wherein each received PCI Express packet further comprises a bus number field and a function number field.

10. The system of claim 1 further comprising the shareable PCI Express switch operable to send PCI Express packets having an assigned context value to an associated network communication device.

11. The system of claim 1 further comprising the shareable PCI Express switch operable to:
receive a PCI Express packet from the associated network communication device;
read the context value stored in the Transaction ID field of the received PCI Express packet; and
send the received PCI Express packet to a selected modular information handling system component based on the context value.

12. The system of claim 1 wherein the sharable PCI Express switch comprises a context assignment module operable to assign a distinct context value to each associated modular information handling system component.

13. A sharable PCI Express switch comprising:
a plurality of ports operable to serially connect with a plurality of information handling system components;
a context assignment module operable to:
receive PCI Express packets from one or more associated modular information handling system components, where each PCI Express packet comprises a Transaction ID field; and
assign a context value within the Transaction ID field of each PCI Express packet received from an associated modular information handling system component, each context value identifying a particular modular information handling system component based upon the port to which the associated modular information handling system connects.

14. The switch of claim 13 further comprising an output port operable to connect with a network communication device.

15. The switch of claim 13 further comprising each of the plurality of ports operable to serially connect with a blade server.

16. The switch of claim 13 further comprising the PCI Express switch operable to send non-encapsulated PCI Express packets to an associated network communication device.

17. The switch of claim 13 further operable to:
receive a PCI Express packet from an associated network communication device;
read the context value stored in the Transaction ID field of the received PCI Express packet; and
send the received PCI Express packet to a selected modular information handling system component associated with the context value.

18. A method for addressing a PCI Express packet comprising:
receiving a PCI Express packet from one of a plurality of associated modular information handling system components;
assigning a context value to the Transaction ID field of the PCI Express packet, the context value identifying the one modular information handling system component.

19. The method of claim 18 further comprising:
receiving a PCI Express packet from an associated network communication device;
identifying the context value stored in the Transaction ID field of the received PCI Express packet; and
sending the received PCI Express packet to a modular information handling system associated with the context value.

20. The method of claim 18 comprising:
identifying a plurality of modular information handling system components associated with a sharable PCI Express switch; and
assigning a distinct context value for each associated modular information handling system component.
